(19) United States
(12) Patent Application Publication
(10) Pub. No.: US 2024/0351040 A1
(43) Pub. Date: Oct. 24, 2024

(54) APPARATUS FOR CONTAINING AND DISPENSING REAGENT INTO A MICROFLUIDIC CARTRIDGE FOR USE IN POINT-OF-CARE DEVICES

(71) Applicant: NOVEL MICRODEVICES, INC., Baltimore, MD (US)

(72) Inventors: Rohan Pais, Baltimore, MD (US); Andrea Pais, Baltimore, MD (US); John Fitzell, Millersville, MD (US); Andrew Grzanka, Cockeysville, MD (US); David Campbell, Bel Air, MD (US); Sean Zakielarz ne, Fallston, MD (US)

(73) Assignee: NOVEL MICRODEVICES, INC., Baltimore, MD (US)

(21) Appl. No.: 18/706,403

(22) PCT Filed: Nov. 1, 2022
(86) PCT No.: PCT/US2022/048637

§ 371 Date: Jul. 14, 2024

Related U.S. Application Data
(60) Provisional application No. 63/274,502, filed on Nov. 1, 2021.

(51) Int. Cl. B01L 3/00

(52) U.S. Cl. CPC B01L 3/523; B01L 2200/16; B01L 2300/044

(57) ABSTRACT

Disclosed herein is an apparatus for containing and dispensing reagent into a microfluidic cartridge for use in sample-to-answer or point-of-care instruments. The apparatus contains a reagent dispensing unit, such as a reagent blister. The blister can contain one or more vessels for containment of reagents and a rupturable seal that blocks the flow of reagent from the reagent blister through an interface and into the microfluidic cartridge.

### CROSS REFERENCE TO RELATED APPLICATIONS

This application is a 35 U.S.C. § 371 national phase non-provisional application of PCT Application Serial No. PCT/US2022/048637 filed on Nov. 1, 2022, which claims priority to U.S. Provisional Application Ser. No. 63/274,502. filed Nov. 1, 2021, the disclosures of which are incorporated by reference as if fully set forth herein.

### TECHNICAL FIELD

The general technical field is diagnostic devices for use in diagnostic testing performed outside of a laboratory setting or at the point of care (POC).

### BACKGROUND

Point of Care (POC) diagnostic devices make diagnostic testing more accessible by bringing the testing to the site of the patient care. These tests can be performed outside of a laboratory setting by operators, skilled and unskilled. As such, POC diagnostic tests preferably should be as simple as possible to reduce the risk of operator error. Some POC tests use disposable cartridges that are prefilled with a “unit dose” of the reagents required for running the test to eliminate the operator errors possible in pipetting reagents for the test. Preferably such cartridges should have a shelf life of at least 6 months stored under room temperature conditions. A popular method of storing single dose wet reagents on a microfluidic cartridge is by packaging the wet reagents in foil blisters.

Conventional reagent filled blisters are similar in construction to the blisters used for pharmaceutical packaging of pills. Often the blister material is made of an aluminum substrate that is coated with a thin plastic or polymer film. The combination of these materials act as a vapor barrier which promotes long term storage of the wet reagents that are contained within the blister. To dispense reagent from these blisters, a force is applied on the blister, which deforms the blister and a seal positioned at the bottom of the blister, which deforms like a diaphragm as the blister layer plastically deforms. The seal impinges onto a rupture spike positioned below the seal causing the seal to tear and open the fluidic pathway from the blister to the microfluidic cartridge. Further crushing of the blister, pushes the reagent out of the blister and into the desired location on the microfluidic cartridge.

Such designs require a substantial force to dispense reagent out of the blister. Moreover, such configurations can be susceptible to unintentional tears on the foil lidding material during transport. For example, cabin pressure changes in an aircraft can cause the seal to impinge on the rupture spike resulting in unwanted tears and contaminated contents. What is needed is a design that is simple to use, easy to manufacture, low in cost, does not require significant force to dispense reagent, and is resistant to tearing or other damage to, for example, the foil lidding material.

### SUMMARY

In accordance with the present invention, various embodiments of an apparatus for containing and dispensing reagent into a microfluidic cartridge for use in point-of-care diagnostic devices and methods of use are disclosed. In one embodiment, a reagent dispensing unit for containing and dispensing reagent into a microfluidic cartridge is provided comprising a reagent blister (or pouch) and at least one plunger. In a related embodiment, the reagent blister can comprise at least one vessel for containment of one or more reagents. The blister can also comprise an interface between the vessel and microfluidic cartridge. The blister can also comprise a rupturable seal blocking the flow of reagent from the reagent blister through the interface and into the microfluidic cartridge. In another related embodiment, the plunger applies pressure to the vessel to actuate dispensing of the reagent into the microfluidic cartridge following rupture of the seal.

In another embodiment, the apparatus for containing and dispensing reagent into a microfluidic cartridge can contain a plurality of vessels in fluid connection with one another. In a related embodiment, the apparatus can contain at least two vessels (e.g., a first vessel and a second vessel) in fluid connection with one another. In one embodiment, the reagent to be dispensed can be in any of the plurality of vessels. In some embodiments, the first vessel can contain the reagent to be dispensed.

In embodiments containing a plurality of vessels, vessels can be different sizes (and shapes), for example, in the embodiment containing two vessels, the first vessel is larger than the second vessel.

In some embodiments, the reagent blister(s) can contain at least one rupturable seal that is positioned at the interface between the first vessel and said microfluidic cartridge. In other embodiments, the rupturable seal can comprise a foil lidding. In another embodiment, the microfluidic cartridge can comprise a channel in fluidic connection with the vessel via the interface through which fluid can flow from the vessel into the cartridge following when the rupturable seal is broken. In a related embodiment, the rupturable seal can underlay the entire reagent blister. In another embodiment, the rupturable seal can be bound to said reagent blister. In some embodiments, rupturable seals can be positioned inside a gap within the microfluidic cartridge, underlay the reagent blister, and extend across the channel at the outlet interface.

In some embodiments, the reagent blister(s) are comprised (in whole or in part) of cold formed blister foil or thermoformed plastic. In another embodiment, the reagent blister(s) are made of a cold formed blister foil.

In other embodiments, the apparatus for containing and dispensing reagent into a microfluidic cartridge can contain a pressure sensitive layer which, in some embodiments, can be disposed between an upper surface of the microfluidic cartridge and the rupturable seal. The pressure sensitive layer can underlie the entire surface area of the rupturable seal, except for the portion of the rupturable seal above the channel, such that it does not hinder fluid flow.

In some embodiments, there are a plurality of plungers each applying pressure to a respective vessel. For example, in a related embodiment containing two plungers, the first plunger can contact and apply pressure to the first vessel and the second plunger can contact and apply pressure to the second vessel.

In some embodiments, one or more of the plungers can contain a protrusion that contacts the rupturable seal within its respective vessel. For example, in the embodiment with two plungers, the second plunger can comprise a protrusion that contacts and applies pressure to the rupturable seal within the second vessel in order to rupture the same.

In one embodiment, the apparatus for containing and dispensing reagent into a microfluidic cartridge can contain an outlet interface for allowing reagent to flow out of the reagent blister and into other parts of the microfluidic cartridge.

In some embodiments, a reagent blister can be formed from the microfluidic cartridge material. In a related embodiment, the reagent blister can include a first vessel and a deformable seal. The deformable seal can be affixed to an exterior surface of the microfluidic cartridge, and in other embodiments, the deformable seal can be proximate to a channel formed in the microfluidic cartridge.

In other embodiments, the apparatus can include at least one piercing bar. In some embodiments, a piercing bar can be formed out of the microfluidic cartridge. In another embodiment, the piercing bar can be positioned proximate to the deformable seal. Piercing bars can include structures, including for example, a lateral arm and a puncture element, in some instances, positioned at the end of the lateral arm. In one embodiment, the lateral arm can extend into the channel proximate the outlet interface and the puncture element can extend in the direction of the at least one rupturable seal.

In one embodiment, a reagent blister can be affixed to an exterior surface of the microfluidic cartridge and include a first vessel and a second vessel. In a related embodiment, the reagent blister can be comprised of cold formed blister foil or thermoformed plastic. In some embodiments, the exterior surface of the microfluidic cartridge can underlie the reagent blister.

In another embodiment, the apparatus can include a reagent blister with a first vessel, a second vessel, and a third vessel. The embodiment can also include a first plunger, a second plunger, and a third plunger. In some related embodiments, the apparatus can include an inlet interface for allowing reagent to flow into the blister and an outlet interface for allowing reagent to flow out of the blister and into the microfluidic device. In another related embodiment, the apparatus can include a rupture bar contained within the blister. The rupture bar can contain a first node, a central portion, a second node, a first connector element connecting said first node to said central portion, and a second connector element connecting said second node to said central portion. The first plunger and third plunger can contain a protrusion extending beyond an exterior surface of the second plunger. The first plunger can contact the first vessel when activated applying pressure to the first vessel and the first node of the rupture. The third plunger can contact the third vessel when activated applying pressure to the third vessel and the second node of said rupture bar. In one embodiment, protrusions of the first plunger and the third plungers engage the vessels and nodes. In another embodiment, the rupturable seal can underlay and seal the blister. The rupturable seal can be affixed to a surface of the microfluidic cartridge with adhesive. In some related embodiments, the microfluidic cartridge can contain a first channel and a second channel below the inlet interface and outlet interface respectively. In other related embodiments, the apparatus can further contain a filtration element positioned below the central portion of rupture bar (e.g., a filtration pad, such as an oleophilic pad). In another related embodiment, the first and second nodes can contain an extension biased toward the inlet interface and outlet interface and said rupturable seal.

In some embodiments, the reagent blister can be a flow through blister. In another embodiment, the flow throw blister can be for mixing reagents and/or separating reagents.

In other embodiments, the apparatus can contain a fluid pressure source for applying positive fluid pressure to the inlet interface. In another embodiment, the fluid pressure source can be an air pump, an air vent which when opened uses gravity to move fluid through the blister, or another fluid filled blister.

In some embodiments, the apparatus can contain a reagent blister formed out of said microfluidic cartridge material; a first plunger and a second plunger; and an inlet interface for allowing reagent to flow into the blister and an outlet interface for allowing reagent to flow out of the reagent blister and into other parts of the microfluidic cartridge. The reagent blister can also contain a first vessel, and a first and second deformable seal, wherein said first and second deformable seal are affixed to an exterior surface of said microfluidic cartridge proximate to channels formed in said microfluidic cartridge. In other related embodiments, the rupturable seal can be positioned inside a gap within the microfluidic cartridge, underlays the reagent blister, and extends across said channels at said outlet and inlet interfaces. In another embodiment, the apparatus can also contain a first and second piercing bar formed out of the microfluidic cartridge and positioned proximate said first and second deformable seals. The first and second piercing bars each can include a lateral am extending into said channels proximate said inlet and outlet interfaces, and a puncture element positioned at the end of said lateral arm and extending in the direction of said at least one rupturable seal. In another related embodiment, the first plunger and the second plunger can each comprise a protrusion that applies pressure to said at least one rupturable seal in order to rupture the same. In a related embodiment, the rupturable seal(s) can be positioned inside a gap within the microfluidic cartridge, underlays the reagent blister, and extends across said channels at said inlet and outlet interfaces. In another related embodiment, the blister can be a flow through blister. Further, the apparatus can include a fluid pressure source for applying positive fluid pressure to the inlet interface, and in some embodiments, the fluid pressure source can be an air pump, an air vent which when opened uses gravity to move fluid through the blister, or another fluid filled blister.

In another embodiment, a microfluidic cartridge for use in a sample-to-answer device comprising: a microfluidic cartridge comprising a reagent blister and a fluidic channel, wherein said reagent blister comprises a first vessel, a second vessel, a third vessel, an inlet interface for allowing reagent to flow into the blister, an outlet interface for allowing reagent to flow out of the blister and into a fluidic channel, and a rupture bar; and a first plunger, a second plunger, and a third plunger.

In yet another embodiment, a sample-to-answer device comprising: a microfluidic cartridge comprising a reagent blister and a fluidic channel, wherein said reagent blister comprises a first vessel, a second vessel, a third vessel, an inlet interface for allowing reagent to flow into the blister, an outlet interface for allowing reagent to flow out of the blister and into a fluidic channel, and a rupture bar; and a first plunger, a second plunger, and a third plunger.

### BRIEF DESCRIPTION OF THE FIGURES

Having thus described the presently disclosed subject matter in general terms, reference will now be made to the accompanying Figures which disclose representative embodiments of the invention.

FIG. 1A-C shows an embodiment of a two vessel reagent blister with a rupturable seal interfacing the microfluidic cartridge.

FIG. 2A-B shows an embodiment of a two vessel reagent blister with a piercing bar molded into the microfluidic cartridge.

FIG. 3A-B shows another embodiment of a two vessel reagent blister with a piercing bar molded into the microfluidic cartridge.

FIG. 4A-B shows an embodiment of a flow through blister with a fluid filled blister providing positive pressure to dispense the contents of the blister.

FIG. 5A-C shows an embodiment of a flow through blister with a rupture bar.

FIG. 6A-C shows an embodiment of a flow through blister with a rupture bar and filter pad.

FIG. 7A-B shows an embodiment of a flow through blister with piercing bars molded into the microfluidic cartridge.

### DETAILED DESCRIPTION

The presently disclosed subject matter now will be described more fully hereinafter with reference to the accompanying Figures, in which some, but not all embodiments of the presently disclosed subject matter are shown. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

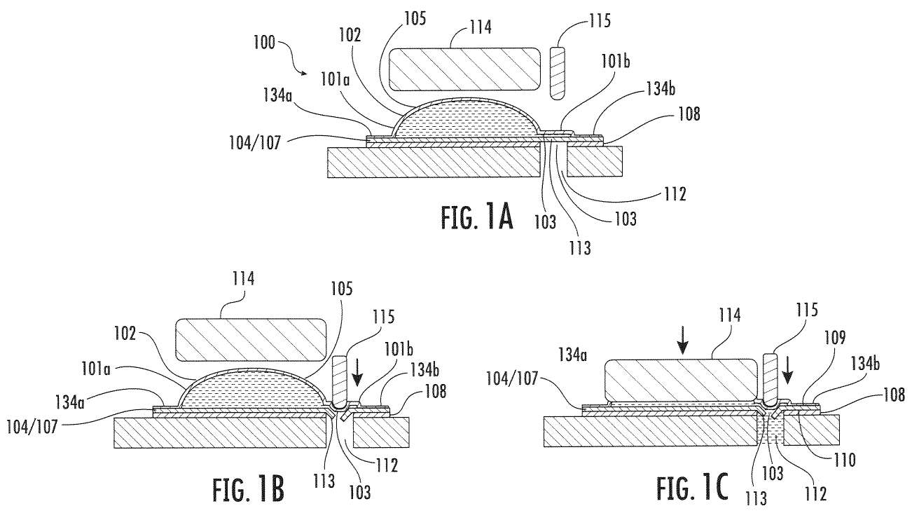

Referring to the embodiment illustrated in FIG. 1A-C, an apparatus for containing and dispensing reagent into a microfluidic cartridge for use in point of care diagnostic devices is shown. In one embodiment, the apparatus can be one or more reagent blisters (shown generally at 100) or reagent pouches. The one or more reagent blisters 100 can comprise one or more vessels 101. FIG. 1 depicts a single reagent blister 100 with a first vessel 101a and a second vessel 101b. It should be understood that reagent blisters can contain more than two vessels. In this embodiment, the two vessels 101a-b are made from cold formed blister foil 102 and one vessel 101a is larger than the other vessel 101b. With continued reference to FIG. 1, the reagent to be dispensed is loaded in the larger first vessel 101a; however, there is a fluidic connection or interface 103 between first and second vessels.

With continued reference to FIG. 1, the blister foil 102 can be sealed (e.g., heat sealed) to a containment member 104 underneath such that the reagent remains confined to the reagent blister 100. In the embodiment depicted in FIG. 1, first and second vessels are sealed to the containment member 104 at two substantially flat flanking members 134a-b. As shown in FIG. 1, a first flanking member 134a flanks the rounded element 105 of first vessel 101a and a second flanking member 134b flanks the elevated surface 106 of second vessel 101b. In some embodiments, the containment member 104 to which the first and second vessels are sealed can be a foil lidding 107.

With continued reference to FIG. 1, in some embodiments, the reagent blister 100 can be affixed to a microfluidic cartridge via bonding agent which forms a bonding layer 108. Bonding layer 108 can comprise an adhesive bond, a weld bond, a thermal bond or the like. In some embodiments. a pressure sensitive adhesive (PSA) forms the bonding layer 108. Other bonding techniques include but are not limited to ultrasonic welding and/or thermal bonding. In one embodiment, the containment member 104 (e.g., foil lidding) can comprise two bond coatings or agents (one on each side) that are activated at two different temperatures. In such a design, a first surface 109 of foil lidding can be bonded to the blister foil 102 at a lower first temperature and a second surface 110 can be bonded to the plastic microfluidic cartridge at a higher second temperature, such as by ultrasonic/thermal bonding. When weld bonding is used. weld joints may be offset from the thermal bonding positions to prevent opening during the weld step.

With continued reference to FIG. 1, in one embodiment, the reagent blister 100 can be affixed to the microfluidic cartridge 111 such that the second vessel 101b is positioned directly above the opening or channel 112 on the microfluidic cartridge 111. In some embodiments, a foil seal 113 under second vessel 101b acts as a rupture valve controlling the dispensing of the reagent. In some embodiments, the foil seal 113 can be a component of the containment member 104. For example, the foil seal 113 can be made of a thinner material than the remaining foil lidding 104 can be made of a thinner material than the remaining foil lidding 104 such that a relatively weak force can rupture the foil seal without damaging the rest of the foil lidding. In some embodiments, this requires tearing the foil seal 113 to open the fluidic pathway and establish a fluidic connection between the vessel and the microfluidic cartridge as illustrated in FIG. 1B.

In some embodiments, the cold formed blister layer 102 can be made of a thick (e.g., ˜20-200 um) aluminum and coated with a polymer film. The material is stiff and holds the shape of the vessel required to contain the reagent after cold forming. In other embodiments, the foil lidding 104 can be made from a thinner foil (e.g., ˜5-35 um thick) and can be also coated with a polymer film to trap vaper and act as a vapor barrier. Additionally, as explained above, the foil lidding 104 can be coated with a heat activated adhesive so it can be heat bonded (or a pressure sensitive adhesive) to the blister foil layer to cause a hermetic seal between the two.

With continued reference to FIG. 1. the fluidic pathway or channel 112 from the blister to the microfluidic cartridge must be opened to dispense the reagent into the microfluidic cartridge. FIG. 1A depicts an embodiment showing two plungers, a first plunger 114 configured to contact and compress the first vessel 101a, and a second plunger 115 configured to contact the second vessel 101b. As shown, first and second plungers can be proximate to first and second vessels-in some embodiments, positioned above the vessels. In this embodiment, to establish a fluidic connection between the reagent blister 100 and the microfluidic cartridge, the fluidic channel 112 is opened through second plunger's interaction on the second vessel 101b. Actuation of the second plunger 115 causes it to engage and press downward upon the cold formed blister foil of second vessel 101b so as to deform the blister foil downwards and break or rupture the foil seal 113 of foil lidding 104. In some embodiments, the cold formed blister foil, is more tear or rupture resistant and capable of withstanding greater pressure than the foil seal 113 or foil lidding 104. In other words, it can withstand more force than the foil lidding material without rupturing.

Once the fluidic channel 112 between the blister to the microfluidic cartridge has been opened and fluidic connection established, the reagent inside the blister will be dispensed. As shown in FIG. 1C, actuation of the first plunger causes it to engage and press downward upon the cold formed blister foil of the first vessel 101a so as to deform the blister foil downwards and push the reagent out of the reagent blister and into the microfluidic cartridge.

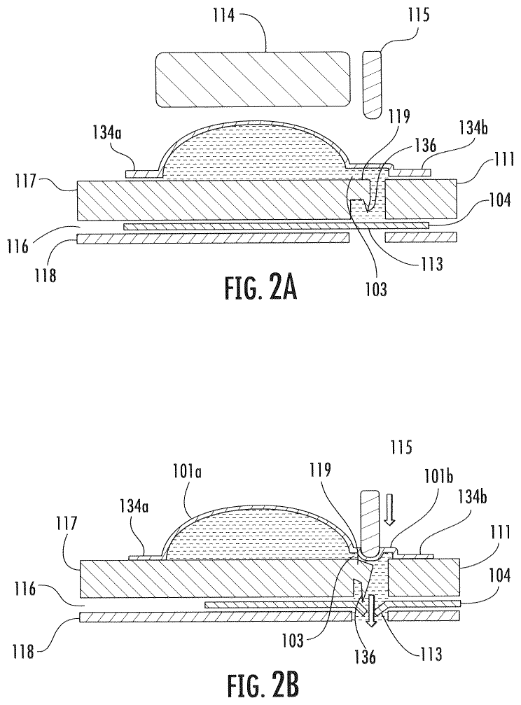

FIG. 2 illustrates an alternative embodiment of a reagent blister 100 with two vessels. The reagent blister shown in FIG. 2 is the same as the embodiment shown in FIG. 1, in all aspects except, in this embodiment, the cold formed blister foil via flanking members 134a-b can be welded directly to the microfluidic cartridge 111. The foil seal 113 or portion of foil lidding 104 directly undemeath the second vessel, in this configuration, again serves as a rupture valve. However, in the embodiment shown in FIG. 2, the foil lidding 104 is encased within a gap 116 between a first microfluidic cartridge layer 117 and a second cartridge layer 118 (e.g., plastic material). As in the previous embodiment, in order to dispense the reagent into the microfluidic cartridge 111, the foil seal 113 must be ruptured to open the fluidic channel 112 from the blister to the microfluidic cartridge. This can be achieved via actuation of the second plunger 115 that is proximate to the second vessel 101b (e.g., directly above) causing the second plunger 115 to engage a piercing bar 118 that is integral to (a single molded component) the first microfluidic cartridge layer 117 causing the piercing bar 118 to deform downwards and push through the foil seal 113 (a section of the foil lidding 104) below. In some embodiments, piercing bar 119 includes a sharp protrusion 136 that engages and ruptures the foil seal. In this embodiment, the second plunger impinges into the second vessel until the foil seal is torn, the fluidic channel opened, and fluidic connection established. In the embodiment shown in FIG. 2 (like the embodiment shown in FIG. 1) actuation of the first plunger causes it to engage and press downward upon the cold formed blister foil of the first vessel 101a so as to deform the blister foil downwards and push the reagent out of the reagent blister and into the microfluidic cartridge.

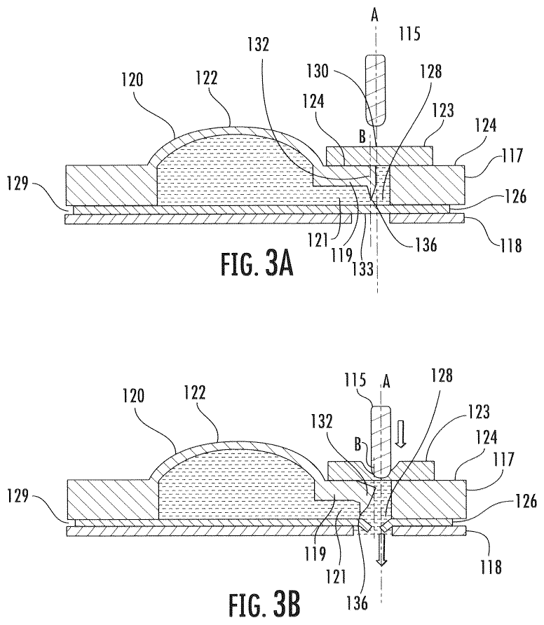

Referring to the embodiment illustrated in FIG. 3, the reagent blister 100 can contain a single vessel 120 and a vessel channel 121. In the embodiment shown in FIG. 3, the reagent blister 100 can be an integral structural component of the microfluidic cartridge and the reagent can be stored entirely inside the microfluidic cartridge layer. For example, the rounded upper portion 122 of the vessel 120 can be made from the same material as the microfluidic cartridge itself or a cold formed blister foil as long as the rounded upper portion can be deformed or pressed downward when a force is applied by the first plunger 114 (not shown in FIG. 3). In this embodiment, a first foil lidding 123 is sealed (e.g., heat sealed) to the upper surface 124 of the first microfluidic cartridge layer 117 which confines he reagent to the vessel 120 from above. The first foil lidding 123 can be made of a material that is tear or rupture resistant. As shown in FIG. 3, a portion of the microfluidic cartridge upper surface 124 to which the first foil lidding 123 is sealed (at least in part) is also an upper surface of a piercing bar 118, which is an integral component of the microfluidic cartridge. Furthermore, the bottom surface of the piercing bar 118 forms an upper wall 125 of vessel channel 121. In the embodiment shown in FIG. 3, the piercing bar 118 can include an arm, 131, a head 132, and a sharp protrusion 119 extending from the head 131, much like the embodiment shown in FIG. 2, which also includes these structures.

With continued reference to FIG. 3, a second foil lidding 126 can be sealed to a bottom surface 127 of the first microfluidic cartridge layer 117 to confine the reagent inside the vessel 120 from underneath. The second foil lidding 126 serves as an interface 128 between the vessel 120 and the fluidic channel 112, as well as a rupture valve. In this embodiment, the second foil lidding 126 can be made of a material that is easily torn or ruptured and thinner than the first foil lidding. The second foil lidding 126 under the vessel 120 acts as a rupture valve for the dispensing of the reagent and can be torn or ruptured to open the fluidic channel 112 between the vessel 120 and remaining microfluidic cartridge components involved in the diagnostic assay process. In this embodiment, the second foil lidding 126 is encased within a gap 129 between a first microfluidic cartridge layer 117 and a second cartridge layer 118 (e.g., plastic material).

To dispense the reagent out of the blister, the second plunger 115 is actuated, which is proximate (e.g., positioned above) the first foil lidding 123 and configured to contact and apply force to the first foil lidding 123 at or near the center point 130 of the first foil lidding 123. In the embodiment shown in FIG. 3, second plunger 123 defines a vertical axis (A) that extends through center point 130, through or adjacent to the head 132, the interface 128, and the fluidic channel 112. Also, as shown in FIG. 3, the protrusion 119 and head 132 define another vertical axis (B) that is slightly offset from the vertical axis (A). Vertical axis (B) extends through an interface 128 center point 133. Once actuated, the second plunger 115 contacts and applies pressure to the first foil lidding 123 on the reagent blister at the first foil lidding center point 130 causing it to deform (e.g., downwards in this embodiment). As second plunger 115 continues to travel deforming the first foil lidding 123, the first foil lidding 123 (while remaining intact/untorn) engages piercing bar head 132 causing it to deform downwards and push through the second foil lidding 126 below. The second plunger 115 impinges into the vessel 120 until the second foil lidding 126 is ruptured. In the embodiment of FIG. 3, the rounded upper portion 122 of the vessel is made of a deformable material, and a mechanically actuated pressure can be applied to the top of the rounded upper portion 122, for example, by a first plunger 114 (not shown in FIG. 3) to deform or press downward upon the vessel and hence dispense the reagent contained within.

The reagent blister can be in the form of a flow through blister that permits the flow of pressurized liquid through the blister. Flow through blisters can serve a valve function, where the blister is ruptured to trigger the flow of reagent through the blister to another location on the microfluidic cartridge. Often flow through blisters serve as mixing chambers, where the pressurized liquid can flow into the flow through blister and mix with existing blister contents. For example, existing blister contents can comprise liquid reagents, bead particles (e.g., magnetic bead particles) and/or solid reagents (e.g., lyophilized reagent pellets). The turbulent flow of liquid promotes mixing. Flow through blisters also sometimes serve as a separator and include a separator element (e.g., a filter or trap) capable of separating components out of the liquid that flows through the blister. For example, oleophilic pads can be used to remove oil from a flow through phased liquid comprising reagent and oil.

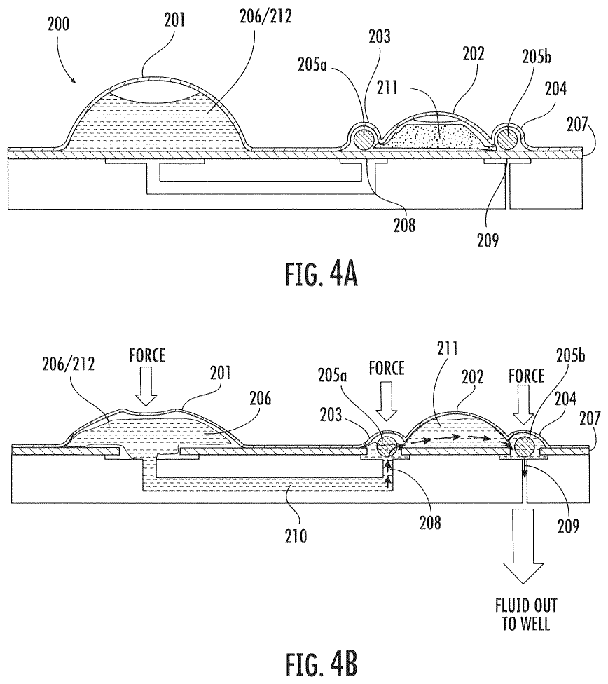

In the embodiment shown in FIG. 4, a reagent blister 200 (flow through) can contain a first vessel 201, a second vessel 202, a third vessel 203, and a fourth vessel 204. Vessels can be made up of cold formed blister foil or cold formed/thermoformed plastic. As shown in FIG. 4, beads can be positioned inside one or more of the vessels and configured to rupture a foil seal when mechanically actuated force is applied to the vessel. For example, beads 205a-b can be positioned inside of the third and fourth vessels that flank the second vessel in this embodiment. One or more reagents 206 (e.g., liquid or solid (lyophilized)) can be placed in one or more of the vessels. As shown in FIG. 4, the vessels can be sealed by foil lidding 207, trapping the beads and the reagents in the vessels. The cold formed blister foil and foil lidding 207 act as vapor barrier for long term storage of the reagents inside the reagent blister 200. In some embodiments, the foil lidding is thin and configured to be ruptured or torn which, in this embodiment, is performed by action of the beads on the foil lidding associated with the third and fourth vessels 203 and 204 or by mechanically actuated force from a plunger alone (without beads) as shown for the first vessel 201. Once tom, the reagents may flow through the reagent blister and be dispensed in the manner shown.

With continued reference to FIG. 4, the blister (e.g., in the form of a blister pack) can be placed on the microfluidic cartridge (not shown), with its inlet 208 and outlet 209 (openings under to the vessels comprising the trapped bead) interfaced with fluidic channels on the microfluidic cartridge. In some embodiments, outlet 209 can be connected to a well on the cartridge which receives the dispensed fluid via fluidic channel. In one embodiment, the inlet 208 can be connected to a source of positive fluidic pressure which, in some embodiments, comprises an air source (e.g., an air pump), an air vent that can be opened permitting gravity potentiated fluid flow or even another fluid filled first vessel 201 (as shown in FIG. 4).

In one embodiment shown in FIG. 4, reagent is dispensed from the blister by applying a mechanically actuated force to the two bead containing vessels 203 and 204 forcing the beads to engage the foil lidding 207. Force is also applied to the first vessel 201 as shown. Foil lidding 207 is ultimately ruptured with continued pressure. Rupturing the foil lidding 207 opens a fluidic channel 210 between first vessel 201 and third vessel 203, opens inlet 208, and opens outlet 209. As mentioned above, outlet 209 interfaces with fluidic channels on the microfluidic cartridge. With continued reference to FIG. 4, opening fluidic channel 210, inlet 208, and outlet 209 permits a positive fluidic pressure that potentiates the flow of reagent from first vessel 201, through fluidic channel 210, through inlet 208, and into second vessel 202 (which may also have contents, such as a second reagent 211 for mixing with a first reagent 212 dispensed from the first vessel 201). As shown in FIG. 4, the positive pressure pushes the mixed reagent out of the second vessel 202 and into the microfluidic cartridge via outlet 209. As mentioned above, FIG. 4 illustrates an embodiment wherein another fluid (either air or liquid) filled vessel 201 is used to apply positive pressure. As explained above, other embodiments could utilize an air pump to provide the positive pressure. Alternatively, gravity can be used to evacuate the reagents out of the blister by opening the inlet of the flow through blister to an air vent and the outlet to the microfluidic cartridge.

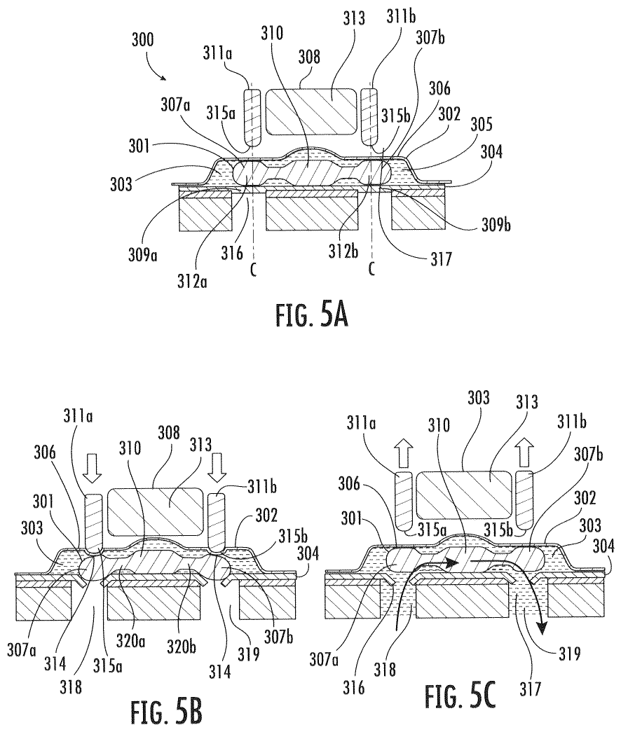

Referring to the embodiment illustrated in FIG. 5, a rupture bar can be used to ensure the fluidic pathway remains open after the foil lidding is torn. Bead blisters, while useful, sometimes clog the flow pathway after rupturing the foil lidding. In some embodiments, the rupture bar can be made from a material that deforms (bends) under external force applied to a vessel and rebounds to its original shape after the removal of the force. FIG. 5 shows a flow through blister 300 containing a rupture bar 301. In some embodiments, the flow through blister 300 can contain one or more vessels made from cold formed blister foil 302 or thermoformed plastic, a reagent 303 to be dispensed either in liquid or dry (lyophilized) format can be contained in said one or more vessels, and a rupture bar 301 can be positioned inside the vessel-that approximately conforms to the size and shape of the one or more vessels, and rests on a foil lidding 304 that seals blister thereby confining the reagent 303 to the interior space 305 of the one or more vessels. The embodiment shown in FIG. 5 contains a single vessel 306.

The rupture bar 301 can comprise one or more nodes 307 that engage the foil lidding 304 when pressure is applied to the blister via plunger 308. In the embodiment shown in FIG. 5, there are two nodes 307a-b corresponding to two rupture points 309a-b of foil lidding 304. As shown, nodes 307a-b are positioned at opposite termini of the rupture bar 301. The rupture bar can also comprise a stabilizer 310, which as shown in FIG. 5, is a central portion connecting the two nodes. In some embodiments, the stabilizer 310 can be at least as thick and longer than either of the two nodes offering extra stability to the rupture bar as pressure is exerted by the plunger. The size of stabilizer 310 affects rupture bar 301 rebounding back to its original shape.

In one embodiment, the shape of the plunger 308 relatively complements the shape of the rupture bar. For example, in FIG. 5, plunger 308 has two flanking protrusions 311a-b that engage the part of the vessel 306 housing the nodes 307a-b. As shown in FIG. 5, flanking protrusions 311a-b define an axis (C) that extends through nodes 307a-b at or near the center point 312a-b of the oval shaped nodes. As shown in FIG. 5, the plunger 308 can include a central portion 313 that extends between the flanking protrusions 311a-b and contacts the part of the vessel 306 housing the stabilizer 310. In some embodiments, central portion also supports the flanking protrusions 311a-b.

In the embodiment shown in FIG. 5, the flanking protrusions 311a-b are elongated and dimensionally smaller overall than the central portion 313 of the plunger. Flanking protrusions 311a-b also extend below (or above depending on orientation) the bottom (or top depending on orientation) surface of the central portion 313. As plunger 308 moves downward, the flanking protrusions 311a-b can engage the vessel surface 314 above its respective node and along axis (C) pressing the node downward and applying pressure to the foil lidding 304. The protrusion ensures that the node applies sufficient force to foil lidding for rupture. In some embodiments, the flanking protrusions 311a-b are configured to move up and down in relation to the central portion. For example, as shown in FIG. 5B, as force is applied to the ends (e.g., top end as shown in the figure) of the flanking protrusions 311a-b, they move slightly further downward than the central portion 313. In the embodiment shown in FIG. 5, force is applied only to the ends 315a-b of flanking protrusions 311a-b and no force is applied to central portion 313.

The flow through blister 300 can be mounted onto a microfluidic cartridge with inlet port 316 and outlet port 317 aligned with fluidic channel openings 318 and 319 on the cartridge. With continued reference to the embodiment illustrated in FIG. 5, reagents are dispensed from the blister beginning with plunger actuation. The plunger with flanking protrusions (as described above) that are spatially positioned above the rupture bar nodes and inlet/outlet ports is moved downwards. The plunger deforms the vessel surface and rupture bar bending flexible connectors 320a-b (connecting stabilizer 310 to nodes 307a-b) causing terminal nodes to move downward (in this embodiment) to engage the foil lidding 304 covering the inlet/outlet ports-eventually causing the foil lidding 304 to tear or rupture. In this embodiment, once the foil lidding 304 is ruptured, the plunger is retracted back causing the rupture bar 301 to rebound to its original shape. With the rupture bar 301 out of the way there is a clear opening for the fluid to flow unimpeded. In some embodiments, to dispense the reagents, a positive fluid pressure can be applied to the inlet 316 of the flow through blister 300. This positive pressure could be either an air source provided by an air pump, an air vent to allow the reagent to flow out of the blister using gravity or even another fluid filled reagent blister pushing the reagent out of the flow through blister.

In the embodiment illustrated in FIG. 5 and described above, the blister is used as a mixing chamber, where the pressurized liquid can flow into the flow through blister mixing with the blister contents already present. As mentioned above, blister contents inside the flow through blister can comprise liquid reagents, solid reagents (e.g., lyophilized reagent pellets), and/or magnetic bead particles. The turbulent flow of liquid inside the blister promotes the mixing. Mixed reagents are then delivered to the desired location on the microfluidic cartridge.

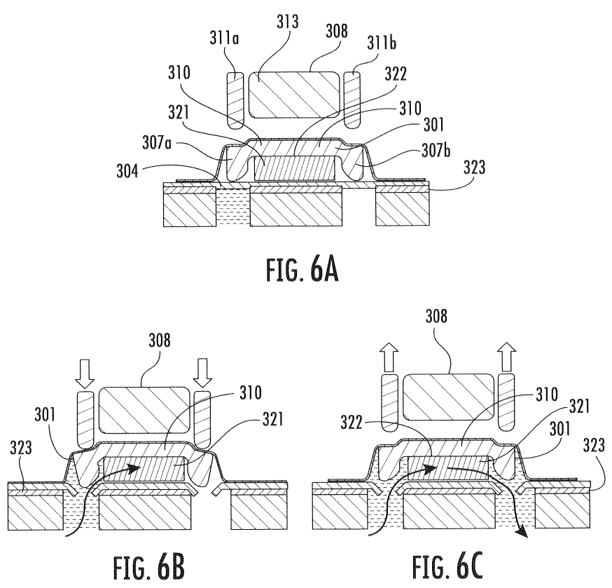

FIG. 6 depicts a similar design to the embodiment shown in FIG. 5, but in this case, the flow through blister is used as a separator. The blister contains a separator element 321 (e.g., a filter or trap) that is configured to separate molecular, chemical, liquid, or particulate components out of the liquid flowing through the blister. For example, such a blister can contain an oleophilic pad that is used to remove oil from a liquid comprising a aqueous reagent and oil. FIG. 6 a rupture bar 301 and separator element 321, in this case a filter pad, used to separate molecular, chemical, liquid, or particulate components from liquid flowing through the blister. Like the embodiment shown in FIG. 5, the plunger 308 and rupture bar 301 act together to open a flow path through the blister by deforming the rupture bar in order to rupture the foil lidding 304. In this embodiment, however, the is positioned in the liquid flow path (shown by the arrows in FIG. 6B-C) inside the blister. The separator element 321 allows the target reagent to pass through the blister into the next channel in the microfluidic cartridge while capturing or blocking other components. In the embodiment shown in FIG. 6, the filter pad 321 is positioned adjacent to the stabilizer 310 of the rupture bar 301. In some embodiments, it is positioned beneath the stabilizer 310 (in some embodiments, stabilizer 310 rests on an exterior surface 322 of the separator element 321) without impeding contact between nodes 307a-b and foil lidding 304. In the embodiment shown in FIG. 6, foil lidding 304 is bound to the microfluidic cartridge surface with a binder 323, for example an adhesive, such as a pressure sensitive adhesive.

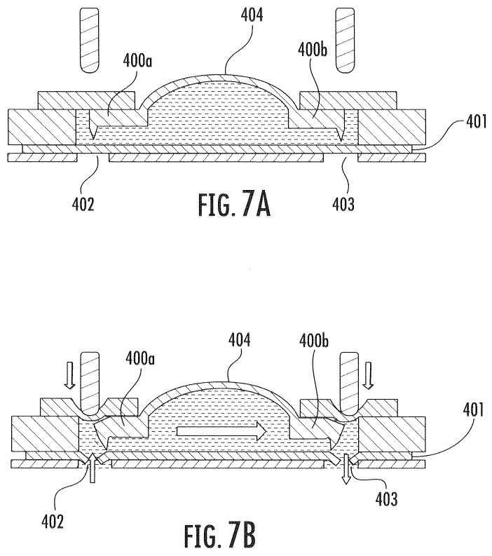

The embodiment illustrated in FIG. 7 is a flow through reagent blister version of the embodiment illustrated in FIG. 3 and described above. In this embodiment, there are two piercing bars 400a-b that rupture the foil lidding 401 covering the fluid inlet 402 and the fluid outlet 403. Another difference between this embodiment and the embodiment shown in FIG. 3, is that pressurized fluid flows through the inlet 402 and into the vessel for mixing with the contents of the vessel 404. The mixed fluid continues to flow through the outlet 403 into the desired microfluidic cartridge location.

Based on the above disclosure, it should be apparent to one of ordinary skill in the art that the apparatus as disclosed above is configured for use in point-of-care sample-to-answer devices or instruments. Thus, the invention described herein also covers point-of-care devices or instruments (or sample-to answer devices or instruments) that include the apparatus for containing and dispensing reagent into a microfluidic cartridge.

Exemplary embodiments can include the following:

An apparatus for containing and dispensing reagent into a microfluidic cartridge for use in point of care diagnostic devices comprising: a reagent blister, wherein said reagent blister comprises at least one vessel, at least one interface between said at least one vessel and said microfluidic cartridge, and at least one rupturable seal blocking the flow of reagent from said reagent blister through the at least one interface and into the microfluidic cartridge; and at least one plunger for applying pressure to said one at least one vessel to actuate dispensing of the reagent into the microfluidic cartridge following rupture of said seal.

The apparatus of the preceding paragraph, comprising at least a first vessel and a second vessel, wherein said first and second vessels are in fluid connection with one another and wherein said first vessel comprises the reagent to be dispensed.

The apparatus of preceding paragraph wherein said first vessel is larger than the second vessel.

The apparatus of the preceding paragraph wherein said at least one rupturable seal is positioned at the interface between said first vessel and said microfluidic cartridge.

The apparatus of the first paragraph, wherein said at least one vessel is made of cold formed blister foil or thermoformed plastic.

The apparatus of the first paragraph wherein said at least one rupturable seal comprises a foil lidding.

The apparatus of the first paragraph wherein said microfluidic cartridge comprises a channel connected to said rupturable seal permitting fluid to flow into said cartridge.

The apparatus of the first paragraph wherein said rupturable seal underlays the entire reagent blister and wherein said rupturable seal is bound to said reagent blister.

The apparatus of the preceding paragraph wherein said reagent blister is made of a cold formed blister foil.

The apparatus of one or more of the preceding paragraphs comprising a pressure sensitive layer between an upper surface of said microfluidic cartridge and said rupturable seal.

The apparatus of one or more of the preceding paragraphs wherein said pressure sensitive layer underlays the entire rupturable seal except for the portion of said rupturable seal above said channel.

The apparatus of one or more of the preceding paragraphs, comprising a first plunger that contacts and applies pressure to said first vessel and a second plunger that contacts and applies pressure to aid second vessel.

The apparatus of one or more of the preceding paragraphs wherein said second plunger comprises a protrusion that applies pressure to said rupturable seal in order to rupture the same.

The apparatus of one or more of the preceding paragraphs further comprising an outlet interface for allowing reagent to flow out of the reagent blister and into other parts of the microfluidic cartridge.

The apparatus of one or more of the preceding paragraphs, wherein said reagent blister is formed out of said microfluidic cartridge material, comprises a first vessel, and a deformable seal, wherein said deformable seal is affixed to an exterior surface of said microfluidic cartridge proximate to a channel formed in said microfluidic cartridge.

The apparatus of one or more of the preceding paragraphs wherein said at least one rupturable seal is positioned inside a gap within the microfluidic cartridge, underlays the reagent blister, and extends across said channel at said outlet interface.

The apparatus of one or more of the preceding paragraphs further comprising at least one piercing bar formed out of the microfluidic cartridge and positioned proximate said deformable seal, wherein said piercing bar comprises a lateral arm extending into said channel proximate said outlet interface, and a puncture element positioned at the end of said lateral arm and extending in the direction of said at least one rupturable seal.

The apparatus of one or more of the preceding paragraphs wherein said reagent blister is affixed to an exterior surface of the microfluidic cartridge and comprises a first vessel and a second vessel.

The apparatus of one or more of the preceding paragraphs wherein said reagent blister is comprised of cold formed blister foil or thermoformed plastic.

The apparatus of one or more of the preceding paragraphs wherein said exterior surface of said microfluidic cartridge underlays the reagent blister.

The apparatus of one or more of the preceding paragraphs wherein said rupturable seal is positioned inside gap within the microfluidic cartridge and extends across a channel formed in said microfluidic cartridge.

The apparatus of one or more of the preceding paragraphs wherein said reagent blister comprises a first vessel, a second vessel, and a third vessel and wherein said apparatus further comprises: a first plunger, a second plunger, and a third plunger; an inlet interface for allowing reagent to flow into the blister and an outlet interface for allowing reagent to flow out of the blister and into the microfluidic device; and a rupture bar contained within the blister.

The apparatus of one or more of the preceding paragraphs wherein said rupture bar comprises a first node, a central portion, a second node, a first connector element connecting said first node to said central portion, and a second connector element connecting said second node to said central portion.

The apparatus of one or more of the preceding paragraphs wherein said first plunger and said third plunger each comprise a protrusion extending beyond an exterior surface of said second plunger.

The apparatus of one or more of the preceding paragraphs wherein said first plunger contacts said first vessel when activated applying pressure to the first vessel and the first node of said rupture bar and wherein said third plunger contacts said third vessel when activated applying pressure to the third vessel and the second node of said rupture bar.

The apparatus of one or more of the preceding paragraphs wherein the protrusions of said first plunger and said third plunger engage the vessels and nodes.

The apparatus of one or more of the preceding paragraphs wherein the rupturable seal underlays and seals the blister and is affixed to a surface of the microfluidic cartridge with adhesive.

The apparatus of one or more of the preceding paragraphs wherein the microfluidic cartridge comprises a first channel and a second channel below the inlet interface and outlet interface respectively.

The apparatus of one or more of the preceding paragraphs further comprising a filtration element positioned below the central portion of rupture bar.

The apparatus of one or more of the preceding paragraphs wherein said first and second nodes each comprise an extension biased toward the inlet interface and outlet interface and said rupturable seal.

The apparatus of one or more of the preceding paragraphs wherein said filtration element is a filtration pad.

The apparatus of one or more of the preceding paragraphs wherein said filtration element is an oleophilic pad.

The apparatus of one or more of the preceding paragraphs wherein the blister is a flow through blister for mixing reagents.

The apparatus of one or more of the preceding paragraphs wherein the blister is a flow through blister for separating reagents.

The apparatus of one or more of the preceding paragraphs wherein the blister is a flow through blister.

The apparatus of one or more of the preceding paragraphs further comprising a fluid pressure source for applying positive fluid pressure to the inlet interface.

The apparatus of one or more of the preceding paragraphs wherein the fluid pressure source is selected from the group consisting of an air pump, an air vent which when opened uses gravity to move fluid through the blister, and another fluid filled blister.

The apparatus of one or more of the preceding paragraphs, further comprising: a reagent blister formed out of said microfluidic cartridge material; a first plunger and a second plunger; and an inlet interface for allowing reagent to flow into the blister and an outlet interface for allowing reagent to flow out of the reagent blister and into other parts of the microfluidic cartridge.

The apparatus of one or more of the preceding paragraphs wherein said reagent blister comprises a first vessel, and a first and second deformable seal, wherein said first and second deformable seal are affixed to an exterior surface of said microfluidic cartridge proximate to channels formed in said microfluidic cartridge.

The apparatus of one or more of the preceding paragraphs wherein said at least one rupturable seal is positioned inside a gap within the microfluidic cartridge, underlays the reagent blister, and extends across said channels at said outlet and inlet interfaces.

The apparatus of one or more of the preceding paragraphs further comprising first and second piercing bars formed out of the microfluidic cartridge and positioned proximate said first and second deformable seals, wherein said first and second piercing bars each comprise a lateral arm extending into said channels proximate said inlet and outlet interfaces, and a puncture element positioned at the end of said lateral arm and extending in the direction of said at least one rupturable seal.

The apparatus of one or more of the preceding paragraphs wherein said first plunger and said second plunger each comprise a protrusion that applies pressure to said at least one rupturable seal in order to rupture the same.

The apparatus of one or more of the preceding paragraphs wherein said at least one rupturable seal is positioned inside a gap within the microfluidic cartridge, underlays the reagent blister, and extends across said channels at said inlet and outlet interfaces.

The apparatus of one or more of the preceding paragraphs wherein the blister is a flow through blister.

The apparatus of one or more of the preceding paragraphs further comprising a fluid pressure source for applying positive fluid pressure to the inlet interface.

The apparatus of one or more of the preceding paragraphs wherein the fluid pressure source is selected from the group consisting of an air pump, an air vent which when opened uses gravity to move fluid through the blister, and another fluid filled blister.

A microfluidic cartridge for use in a sample-to-answer device comprising: a microfluidic cartridge comprising a reagent blister and a fluidic channel, wherein said reagent blister comprises a first vessel, a second vessel, a third vessel, an inlet interface for allowing reagent to flow into the blister, an outlet interface for allowing reagent to flow out of the blister and into a fluidic channel, and a rupture bar; and a first plunger, a second plunger, and a third plunger.

A sample-to-answer device comprising: a microfluidic cartridge comprising a reagent blister and a fluidic channel, wherein said reagent blister comprises a first vessel, a second vessel, a third vessel, an inlet interface for allowing reagent to flow into the blister, an outlet interface for allowing reagent to flow out of the blister and into a fluidic channel, and a rupture bar; and a first plunger, a second plunger, and a third plunger.

### General Definitions

Although specific terms are employed herein, they are used in a generic and descriptive sense only and not for purposes of limitation. Unless otherwise defined, all technical and scientific terms used herein have the same meaning as commonly understood by one of ordinary skill in the art to which this presently described subject matter belongs.

“Nucleic acid” as used herein means a polymeric compound comprising covalently linked subunits called nucleotides. A “nucleotide” is a molecule, or individual unit in a larger nucleic acid molecule, comprising a nucleoside (i.e., a compound comprising a purine or pyrimidine base linked to a sugar, usually ribose or deoxyribose) linked to a phosphate group.

“Polynucleotide” or “oligonucleotide” or “nucleic acid molecule” are used interchangeably herein to mean the phosphate ester polymeric form of ribonucleosides (adenosine, guanosine, uridine or cytidine; “RNA molecules” or simply “RNA”) or deoxyribonucleosides (deoxyadenosine, deoxyguanosine, deoxythymidine, or deoxycytidine; “DNA molecules” or simply “DNA”), or any phosphoester analogs thereof, such as phosphorothioates and thioesters, in either single-stranded or double-stranded form. Polynucleotides comprising RNA, DNA, or RNA/DNA hybrid sequences of any length are possible. Polynucleotides for use in the present invention may be naturally-occurring, synthetic, recombinant, generated ex vivo, or a combination thereof, and may also be purified utilizing any purification methods known in the art. Accordingly, the term “DNA” includes but is not limited to genomic DNA, plasmid DNA, synthetic DNA, semisynthetic DNA, complementary DNA (“cDNA”; DNA synthesized from a messenger RNA template), and recombinant DNA (DNA that has been artificially designed and therefore has undergone a molecular biological manipulation from its natural nucleotide sequence).

“Amplify,” “amplification,” “nucleic acid amplification,” or the like, refers to the production of multiple copies of a nucleic acid template (e.g., a template DNA molecule), or the production of multiple nucleic acid sequence copies that are complementary to the nucleic acid template (e.g., a template DNA molecule).

The terms “top,” “bottom,” “over,” “under,” and “on” are used throughout the description with reference to the relative positions of components of the described devices, such as relative positions of top and bottom substrates within a device. It will be appreciated that the devices are functional regardless of their orientation in space.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads. microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material. coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres. coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles. ferromagnetic microparticles and nanoparticles, coated ferromagnetic microparticles and nanoparticles. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe304, BaFe12019, CoO, NiO, Mn203, Cr203, and CoMnP.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

All publications, patent applications, patents, and other references (including references to specific commercially available products or product lines) mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

What is claimed is:

1-48. (canceled)

49. An apparatus for containing and dispensing reagent into a microfluidic cartridge for use in point-of-care devices comprising:
a reagent blister, wherein said reagent blister comprises at least a first vessel and a second vessel in fluid connection with one another, wherein said first vessel comprises a reagent to be dispensed, at least one interface between said first and second vessels and said microfluidic cartridge, and at least one rupturable seal blocking the flow of a reagent from said reagent blister through the at least one interface and into the microfluidic cartridge; and
at least one plunger for applying pressure to said first and/or second vessel one at-to actuate dispensing of the reagent into the microfluidic cartridge following rupture of said seal.

50. The apparatus of claim 49, wherein said at least one rupturable seal is positioned at the interface between said first vessel and said microfluidic cartridge.

51. The apparatus of claim 49, wherein said at least one rupturable seal comprises a foil lidding.

52. The apparatus of claim 49, wherein said microfluidic cartridge comprises a channel connected to said rupturable seal allowing fluid to flow into said cartridge.

53. The apparatus of claim 49, wherein said rupturable seal underlays the entire reagent blister and wherein said rupturable seal is bound to said reagent blister.

54. The apparatus of claim 52, comprising a pressure sensitive layer between an upper surface of said microfluidic cartridge and said rupturable seal.

55. The apparatus of claim 54, wherein said pressure sensitive layer underlays the entire rupturable seal except for the portion of said rupturable seal above said channel.

56. The apparatus of claim 49, comprising a first plunger that contacts and applies pressure to said first vessel and a second plunger that contacts and applies pressure to aid second vessel.

57. The apparatus of claim 56, wherein said second plunger comprises a protrusion that applies pressure to said rupturable seal in order to rupture the same.

58. The apparatus of claim 49, further comprising an outlet interface for allowing reagent to flow out of the reagent blister and into other parts of the microfluidic cartridge.

59. The apparatus of claim 52, wherein said at least one rupturable seal is positioned inside a gap within the microfluidic cartridge, underlays the reagent blister, and extends across said channel at said outlet interface.

60. The apparatus of claim 59, further comprising at least one piercing bar formed out of the microfluidic cartridge and positioned proximate said deformable seal, wherein said piercing bar comprises a lateral arm extending into said channel proximate said outlet interface, and a puncture element positioned at the end of said lateral arm and extending in the direction of said at least one rupturable seal.

61. The apparatus of claim 49 wherein said reagent blister is affixed to an exterior surface of the microfluidic cartridge that underlays the reagent blister.

62. An apparatus for containing and dispensing reagent into a microfluidic cartridge for use in point-of-care devices comprising:
a reagent blister, wherein said reagent blister comprises a first vessel, a second vessel, and a third vessel;
a first plunger, a second plunger, and a third plunger;
an inlet interface for allowing reagent to flow into the reagent blister and an outlet interface for allowing reagent to flow out of the reagent blister and into the microfluidic device; and
a rupture bar contained within the reagent blister.

63. The apparatus of claim 62, wherein said rupture bar comprises a first node, a central portion, a second node, a first connector element connecting said first node to said central portion, and a second connector element connecting said second node to said central portion.

64. The apparatus of claim 63, wherein said first plunger and said third plunger each comprise a protrusion extending beyond an exterior surface of said second plunger.

65. The apparatus of claim 62, further comprising a rupturable seal that underlays and seals the reagent blister and is affixed to a surface of the microfluidic cartridge with adhesive.

66. The apparatus of claim 65, wherein the microfluidic cartridge comprises a first channel and a second channel below the inlet interface and outlet interface respectively.

67. The apparatus of claim 66, further comprising a filtration element positioned below the central portion of rupture bar.

68. The apparatus of claim 62, wherein said first and second nodes each comprise an extension biased toward the inlet interface and outlet interface and said rupturable seal.

69. The apparatus of claim 67, wherein said filtration element is a filtration pad or an oleophilic pad.

70. The apparatus of claim 69, wherein the reagent blister is a flow through blister.

71. The apparatus of claim 70, wherein the flow through blister is configured for separating and/or mixing reagents.

72. The apparatus of claim 62, further comprising a fluid pressure source for applying positive fluid pressure to the inlet interface.

73. The apparatus of claim 72, wherein the fluid pressure source is selected from the group consisting of an air pump, an air vent which when opened uses gravity to move fluid through the blister, and another fluid filled blister.

74. The apparatus of claim 49, further comprising:
a reagent blister formed out of said microfluidic cartridge material;
a first plunger and a second plunger; and
an inlet interface for allowing reagent to flow into the blister and an outlet interface for allowing reagent to flow out of the reagent blister and into other parts of the microfluidic cartridge.

75. The apparatus of claim 74, wherein said reagent blister comprises a first vessel, and a first and second deformable seal, wherein said first and second deformable seal are affixed to an exterior surface of said microfluidic cartridge proximate to channels formed in said microfluidic cartridge.

76. The apparatus of claim 75, wherein said at least one rupturable seal is positioned inside a gap within the microfluidic cartridge, underlays the reagent blister, and extends across said channels at said outlet and inlet interfaces.

77. The apparatus of claim 76, further comprising first and second piercing bars formed out of the microfluidic cartridge and positioned proximate said first and second deformable seals, wherein said first and second piercing bars each comprise a lateral arm extending into said channels proximate said inlet and outlet interfaces, and a puncture element positioned at the end of said lateral arm and extending in the direction of said at least one rupturable seal.

78. The apparatus of claim 77, wherein said first plunger and said second plunger each comprise a protrusion that applies pressure to said at least one rupturable seal in order to rupture the same.

79. The apparatus of claim 78, wherein said at least one rupturable seal is positioned inside a gap within the microfluidic cartridge, underlays the reagent blister, and extends across said channels at said inlet and outlet interfaces.

80. The apparatus of claim 74, wherein said blister is a flow through blister and wherein said apparatus further comprises a fluid pressure source for applying positive fluid pressure to the inlet interface.

81. The apparatus of claim 80, wherein the fluid pressure source is selected from the group consisting of an air pump, an air vent which when opened uses gravity to move fluid through the blister, and another fluid filled blister.

82. A sample-to-answer device comprising:
a microfluidic cartridge comprising a reagent blister and a fluidic channel, wherein said reagent blister comprises a first vessel, a second vessel, a third vessel, an inlet interface for allowing reagent to flow into the blister, an outlet interface for allowing reagent to flow out of the blister and into a fluidic channel, and a rupture bar; and
a first plunger, a second plunger, and a third plunger.
